(19) United States
(12) Patent Application Publication
(10) Pub. No.: US 2022/0285886 A1
(43) Pub. Date: Sep. 8, 2022

(54) HIGH-SPEED COMMUNICATION CONNECTOR CAPABLE OF IMPROVING TRANSMISSION QUALITY AND OF CONTROLLING TRANSMISSION CHARACTERISTICS

(71) Applicant: EL TECH Co., Ltd., Daejeon (KR)

(72) Inventors: Hyun-Su YUN, Daejeon (KR); Jong-Moon KIM, Daejeon (KR); Dong-Won YANG, Daejeon (KR)

(73) Assignee: EL TECH Co., Ltd., Daejeon (KR)

(21) Appl. No.: 17/638,729

(22) PCT Filed: Aug. 25, 2020
(86) PCT No.: PCT/KR2020/011309

§ 371 Date: Feb. 25, 2022

(30) Foreign Application Priority Data
Aug. 27, 2019 (KR) 10-2019-0105444

(51) Int. Cl. H01R 13/6473; H01R 12/73; H01R 13/6591

(52) U.S. Cl. CPC H01R 13/6473; H01R 12/732; H01R 13/6591

(57) ABSTRACT

A high-speed communication connector capable of improving transmission quality and of controlling transmission characteristics is disclosed. The connector is a board-to-board-type connector for high-speed data communication in band of 10 to 25 GHz, and is constructed so as to reduce signal interference by virtue of a finger body having a PCB structure and shield structures between signal lines of a receptacle body filled with a dielectric material and to realize matching between impedances by virtue of the dielectric material and the signal lines.

### BACKGROUND OF THE INVENTION

### Field of the Invention

The present invention relates to a high-speed communication connector, and more particularly to a high-speed communication connector capable of improving transmission quality and of controlling transmission characteristics, which is a board-to-board-type connector for high-speed data communication in a band of 10 to 25 GHz and which is constructed so as to reduce signal interference by virtue of a finger body having a PCB structure and shield structures between signal lines of a receptacle body filled with a dielectric material and to realize matching between impedances by virtue of the dielectric material and the signal lines.

### Description of the Related Art

With the development of information technology, there is a requirement to support circumstances in which large amounts of data are transmitted and received at high speeds due to the increased processing speed of digital components. Accordingly, research and development of conductive cables and connectors for signal transmission and signal transmission media for optical communication has been actively conducted.

When the frequency used for communication is increased, individual transmission lines progressively take on the characteristics of antennas, and thus radiate large amounts of electromagnetic energy. Consequently, a coupling phenomenon causing interaction of energy in transmission lines in an RF circuit has a significant influence on communication performance.

In other words, signal interference between transmission lines has a significant influence on communication quality during transmission of high-frequency signals. Particularly, the influence on communication quality is further increased when signals are transmitted in parallel.

Although serial communication, which has good signal transmission characteristics and is configured to enable long-distance transmission, is used in order to avoid the above problems, there is a problem that occurs upon conversion of parallel signals into serial signals at a transmitting side and reverse conversion at a receiving side, and a disadvantage in that the use of additional components is required. Particularly, there is a trend away from use of a right-angled structure because it is difficult to match impedances for serial communication.

In order to solve the problems with a conventional serial communication and to realize high-speed communication, optical communication using light is also used for high-speed signal transmission. However, optical communication exposes problems in that the size of components that are essentially used therein is increased and in that a wave guide for high-speed communication is difficult to manufacture and very expensive.

Meanwhile, although a connector configured to realize connection via conductive wires offers a great advantage from a cost point of view and exhibits improved performance without causing major problem in a low-frequency band, signal interference is increased and transmission efficiency is deteriorated in a high-frequency band, thereby causing considerable difficulty in actual use.

Although there is a technical structure configured simply to shield signal lines in order to prevent such signal interference, this technology is capable of being used for transmission of signals only up to the band of hundreds of MHz, but is incapable of solving problems in matching between impedance, which is important in transmission of signals in a GHz band.

### SUMMARY OF THE INVENTION

Therefore, the present invention has been made in view of the above problems, and it is an object of the present invention to provide a high-speed communication connector capable of improving transmission quality and of controlling transmission characteristics, which is configured to improve communication efficiency by making it easy to match impedances while suppressing interference between signal lines in a board-to-board-type high-speed data communication using a connector.

In accordance with the present invention, the above and other objects can be accomplished by the provision of a high-speed communication connector, which is of a board-to-board type and is capable of improving communication quality and of controlling communication characteristics, the high-speed communication connector including a finger body formed at one side of a PCB, the finger body including a plurality of anode terminals formed on one side thereof at predetermined intervals, a plurality of cathode terminals formed on another side thereof at predetermined intervals so as to be symmetrical with the plurality of anode terminals, and shield bodies made of conductive material and formed inside and between the plurality of anode terminals and inside and between the plurality of cathode terminals at predetermined intervals, and a receptacle body having a groove formed in a side surface thereof so as to be engaged with the one surface and the another surface of the finger body, the receptacle body including a plurality of anode pins and a plurality of cathode pins, which are respectively brought into contact with the plurality of anode terminals and the plurality of cathode terminals for electrical connection, shield plates made of conductive material, the shield plates being interposed between differential lines, each of which is composed of one of the anode pins and a corresponding one of the cathode pins, at predetermined intervals so as to distinguish the differential lines from each other, and pieces of dielectric material having a low permittivity and disposed in spaces defined between the anode pins, the cathode pins, and the shield plates, other than the groove, so as to form a body of the receptacle body, the pieces of dielectric material being selectively controlled in kind and amount so as to control impedances in correspondence with frequency bands corresponding to the differential lines which are isolated from each other by means of the shield plates.

Each of the pieces of dielectric material may be selected from among Teflon, polyethylene, resin, gutta-percha, Lucite, paraffin, Styrofoam, Vaseline and ceramic. Alternatively, each of the pieces of dielectric material may be a combination of two or three selected from among the above dielectric materials. When the frequency is changed, an appropriate dielectric material or combination of dielectric materials may be selected in consideration of the frequency.

The anode pins and the cathode pins may include contact portions, which are respectively brought into contact with the anode terminals and the cathode terminals, linear portions spaced apart from and parallel to each other, and exposure portions, which are bent in a predetermined direction so as to be exposed to an outside of each piece of dielectric material.

Each of the anode pins and each of the cathode pins may include respective bent portions, which are bent in a predetermined direction, and one of each of the anode pins and each of the cathode pins, which is positioned at a lower level, may include a curved portion formed at the bent portion thereof such that the anode pins and the cathode pins have the same length.

The curved portion may have a radius of curvature equal to or less than twice the width of the anode pin or the cathode pin.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a finger body according to an embodiment of the present invention;

FIG. 2 is a front cross-sectional view illustrating the finger body according to the embodiment of the present invention;

FIG. 3 is a perspective view illustrating a receptacle body according to an embodiment of the present invention;

FIG. 4 is a perspective view illustrating the receptacle body according to an embodiment of the present invention; and

FIGS. 5 and 6 are perspective views illustrating the finger body and a differential pin body according to an embodiment of the present invention before and after coupling therebetween.

### DETAILED DESCRIPTION OF THE INVENTION

Hereinafter, a high-speed communication connector capable of improving communication quality and of controlling communication characteristics according to the present invention will be described in detail with reference to the accompanying drawings.

The high-speed communication connector according to the present invention is a board-to-board-type connector for high-speed communication at 5 GHz or higher (typically to 25 GHz). This kind of connector includes both a receptacle body 2 configured to receive pins and a finger body 1 configured to be fitted into the receptacle body 2.

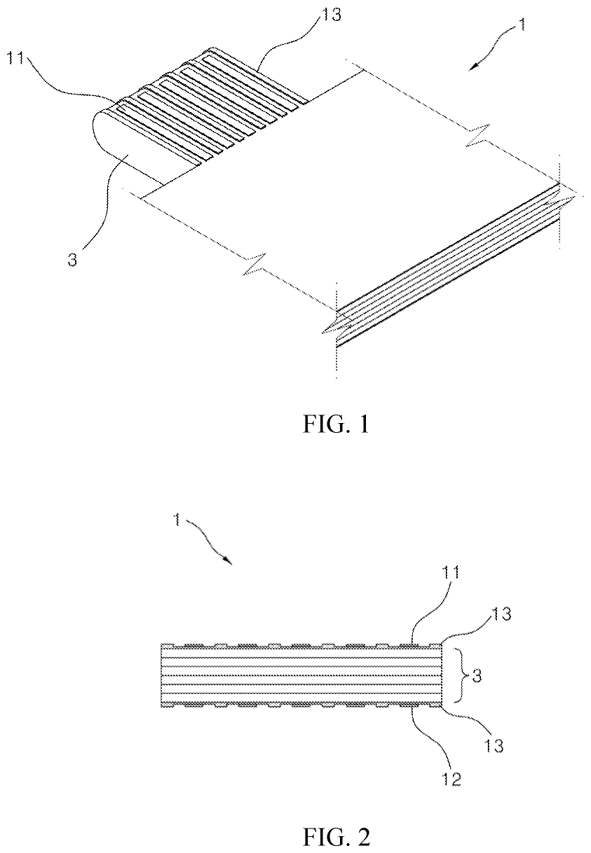

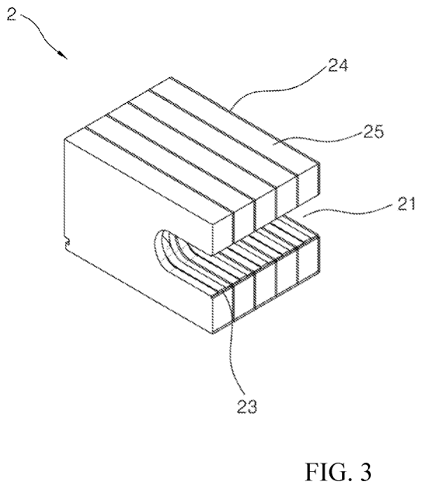

FIG. 1 is a perspective view illustrating the finger body according to an embodiment of the present invention. FIG. 2 is a front cross-sectional view illustrating the finger body according to the embodiment of the present invention, which is configured to have a PCB structure.

Specifically, a PCB plate 3 is integrally provided with a plurality of anode terminals 11 and a plurality of cathode terminals 12 at regular intervals such that the plurality of anode terminals 11 are formed on one surface of the PCB plate 2 and the plurality of cathode terminals 12 are formed on the opposite surface of the PCB plate 3 so as to be respectively symmetrical with the plurality of anode terminals 11. Because a typical PCB plate has a plurality of layers, the anode terminals and the cathode terminals are formed on the outermost layers of the PCB plate, that is, on the upper side and the lower side of the PCB plate in the drawing. Although the drawing illustrates an embodiment in which the anode terminals 11 are formed on the upper side of the PCB plate 3 and the cathode terminals 12 are formed on the lower side of the PCB plate 3, it will be apparent that the anode terminals 11 and the cathode terminals 12 may be reversely disposed as necessary.

Although the number of anode terminals 11 and the number of cathode terminals 12 may be changed as appropriate depending on communication characteristics, it is preferable that five or more pairs of anode terminals and five or more pairs of cathode terminals 12 be provided for efficient high-speed communication.

The plurality of anode terminals 11 and cathode terminals 12 are arranged on the upper and lower surfaces of the PCB plate 3 in a lateral direction at predetermined intervals, preferably at regular intervals. Shield bodies 13, each of which is made of a conductive material, are provided between respective ones of the anode terminals 11 and between respective ones of the cathode terminals 12 at predetermined intervals, and are also provided between the anode terminals 11 and the cathode terminals 12.

Specifically, the shield bodies 13 are formed between the plurality of anode terminals 11 with gaps therebetween and between the plurality of cathode terminals 12 with gaps therebetween, and are also formed between the anode terminals 11 and the cathode terminals 12, so as to greatly reduce signal interference between the terminals and attenuation of transmitted signals.

Assuming that the width of each of the anode terminals 11 and the cathode terminals 12 is set to be 0.3 mm, the gap between each of the terminals and each of the shield bodies may be set to be about 0.2 mm, and the thickness of each of the shield bodies 13 may be set to be about 0.2 mm. However, the dimensions may be changed depending on communication characteristics, and are not limited thereto.

Various embodiments may be realized depending on the kind and structure of the PCB plate. In the case of a PCB plate having ten layers, the anode terminals 11 may be provided in the first layer, and the cathode terminals 12 may be provided in the tenth layer. The shield bodies 13 may be symmetrically provided in the second layer and the ninth layer so as to have the same shape, and the remaining layers of the PCB plate may be configured to have a general structure of type that is well-known in the art. The height of the terminals may be the same as the height of the shield bodies 13 so as to be flush therewith in consideration of coupling with the receptacle body 2, which will be described later.

By virtue of this structure, the shield bodies 13 of the finger body 1 may be easily manufactured through the same method as a method of manufacturing a PCB, and wide intermediate layers of a multi-layered PCB may be formed using the shield bodies.

In other words, although a conventional finger body of a connector is configured to have no signal separation function, the present invention is able to greatly improve the signal separation function by applying the shield bodies 13, serving as a ground, to the plurality of layers of the PCB constituting the finger body 1. In addition, although it is difficult and considerably time-consuming to manufacture a structure for individually connecting conductive wires, which are used in a conventional high-frequency connector, because pins of the finger body have complicated shapes, the present invention enables the finger body 1 to be manufactured at low cost.

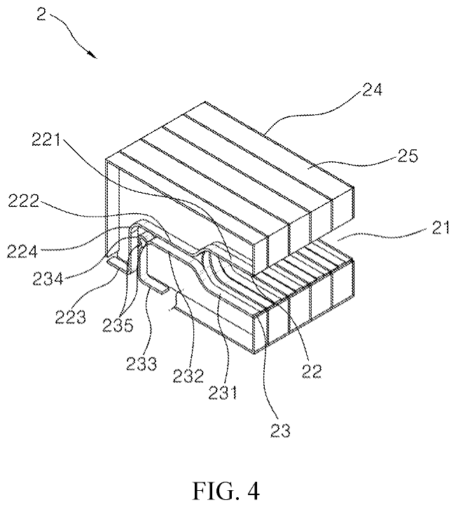

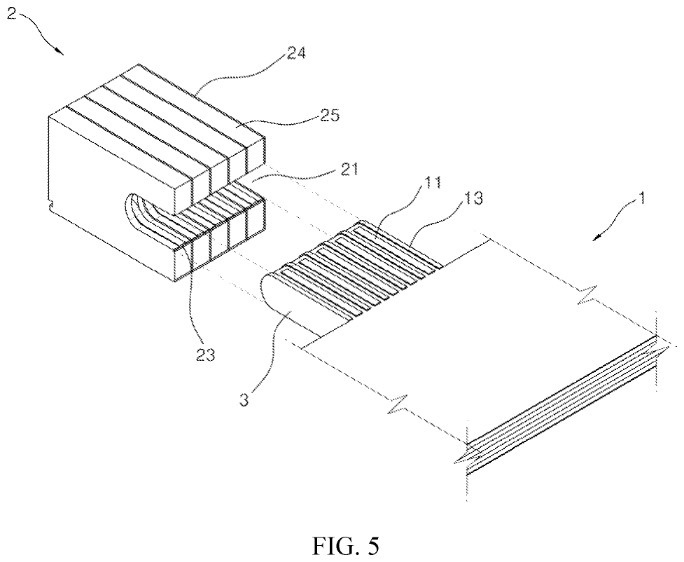

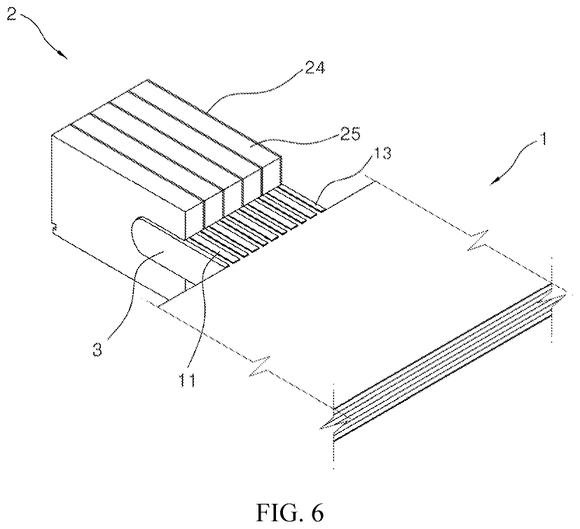

FIG. 3 is a perspective view illustrating the receptacle body according to an embodiment of the present invention. FIG. 4 is a perspective view illustrating the receptacle body according to an embodiment of the present invention. FIGS. 5 and 6 are perspective views illustrating the finger body and a differential pin body according to an embodiment of the present invention before and after coupling therebetween.

The receptacle body 2 has a groove 21 formed in one side surface thereof so as to be engaged with one surface of the finger body 1 and the surface opposite thereto in the state of covering the two surfaces.

The groove 21 is provided on the inner surface thereof with a plurality of anode pins 22, which are respectively brought into contact with the anode terminals 11 of the finger body 1 for electrical connection, and a plurality of cathode pins 23, which are respectively brought into contact with the cathode terminals 12 for electrical connection. For efficient communication, the anode pins 22 and the cathode pins 23 are provided in a number and at positions so as to respectively correspond to the anode terminals 11 and the cathode terminals 12. Shield plates 24 are interposed between the pairs of anode pins 22 and cathode pins 23 at a predetermined interval, that is, at the same interval as the interval between shield bodies 13 interposed between the anode terminals 11 and between the cathode terminals 12. Here, it is preferable that the shield bodies 13 be disposed at the same interval as the interval between the shield plates 24 so as to respectively come into contact with the shield plates 24.

When the finger body 1 is coupled to the receptacle body 2, the shield bodies 13 may be connected to the shield plates 24 in the state of being properly aligned with the shield plates 24, and may be connected to the reference potential so as to be grounded, thereby electromagnetically separating signal lines. To this end, each of the shield plates 24 is configured to have an “L” shape or a “U” shape, and is expanded throughout the anode pins 22 and the cathode pins 23. The shield plates 24 are made of a highly conductive material.

The shield bodies 13 and the shield plates 24 are made of conductive material so as to serve as a ground, and are configured to respectively separate electrodes and pins, which are signal transmission units, thereby reducing interference between signal lines, which is problematic in high-frequency signals, greatly reducing attenuation of transmitted signal, and controlling the characteristics of the connector.

The spaces defined between the anode pins 22, the cathode pins 23 and the shield plates 24, other than the groove 21, is filled with pieces of dielectric material 25 each having a low permittivity so as to form the main body of the receptacle body 2.

The pieces of dielectric material 25 are the constituent objects of the receptacle body 2 constituting the connector. The pieces of dielectric material 25 serve to facilitate control of impedances and matching between impedances, which is the principal characteristic of the connector, to thus improve communication quality through control of the pieces of dielectric material 25.

In the case of a low-frequency band, particularly an MHz band, no big signal transmission problem occurs even when attention is not paid to impedance matching. However, in the case of a high-frequency band of several GHz or higher, there are problems of increased wave reflection, increased signal loss, and the like when impedances do not match.

Depending on the frequency band, impedance changes, and the requirements for matching between impedances also change. Accordingly, for optimal signal transmission and matching between impedances, it is critical to control the impedance.

Impedance (capacitive) may be represented as the following Equation 1:

$${X}_{C} = \frac{1}{j ω C} \qquad [ Equation 1 ]$$

wherein C is capacitance.

In addition, the relationships between a dielectric material and capacitance may be represented as the following Equation 2:

$$C = {ɛ}_{0} {ɛ}_{r} \frac{A}{d} \qquad [ Equation 2 ]$$

wherein A is a facing area, d is the distance between electrodes, ε0 is the permittivity of air, and εr is the specific permittivity of a dielectric material.

Due to these characteristics, a dielectric material having a low permittivity is used as the dielectric material 25, which constitutes the receptacle body 2, in the case of a high-frequency band of 10 GHz or higher. In order to fill the receptacle body 2 with the dielectric material 25, various measures, such as using an adhesive, may be taken.

Specifically, the dielectric material 25 is preferably composed of one selected from among Teflon, polyethylene, resin, gutta-percha, Lucite, paraffin, Styrofoam, Vaseline, and ceramic. In addition, the dielectric material 25 is also preferably composed of a combination of two or three selected from among Teflon, polyethylene, resin, gutta-percha, Lucite, paraffin, Styrofoam, Vaseline, and ceramic. When the frequency is changed, it is possible to select an appropriate dielectric material or combination of dielectric materials in consideration of the frequency.

Because a conventional connector includes a hollow receptacle, there is a problem in that it is difficult to set impedance according to a frequency band. However, because the connector according to the present invention is constructed such that the spaces between the anode pins 22, the cathode pins 23, and the shield plates 24 are filled with a material having a low permittivity, it is possible to realize a low dielectric state and to control impedance.

According to the present invention, the multiple pairs of anode pins 22 and cathode pins 23, which are the differential lines of the receptacle body 2, are capable of being filled with dielectric material, and the differential lines are isolated from each other by means of the shield plates 24, and are thus attached to each other via an adhesive or the like. Accordingly, the differential lines may be provided with different pieces of dielectric material suitable for different frequencies or requirements so as to realize matching between impedances when necessary. In addition, it is also easy to apply dielectric material for matching between impedances in the case of a single line, other than the differential lines.

As illustrated in the accompanying drawings, the present invention is also able to realize matching between lengths in the case of right-angle-type connector.

In this structure, each of the anode pins 22 and a corresponding one of the cathode pins 23 of the receptacle body 2 are spaced apart from and parallel to each other so as to allow the finger body 1 to be fitted therebetween, and are respectively provided with contact portions 221 and 231, which are respectively brought into contact with the anode terminal 11 and the cathode terminal 12. Each of the anode pins 22 and a corresponding one of the cathode pins 23 of the receptacle body 2 may include adjustment portions for appropriately adjusting the distance between the anode pin 22 and the cathode pin 23, linear portions, which are positioned behind the adjustment portions and are spaced apart from and parallel to each other so as to maintain the distance between the anode pin 22 and the cathode pin 23, and exposure portions 223 and 233, which are bent in a predetermined direction so as to be exposed to the outside of the pieces of dielectric material 25 to thus transmit signals to another board.

Although the angle at which the anode pin 22 and the cathode pin 23 are bent toward the exposure portions 223 and 233 is not limited, the bent portions 224 and 234 according to the embodiment are bent downwards at 90 degrees, corresponding to a typical right-angle-type connector.

Specifically, each of the anode pins 22 and each of the cathode pins 23 include respective bent portions 224 and 234, which are bent in a predetermined direction, that is, in a downward direction, at 90 degrees. In this case, the length of the cathode pin 23 that is positioned at a lower level becomes shorter than the length of the anode pin 22 that is positioned at a higher level thereby forming a difference in length therebetween.

Accordingly, according to the present invention, among the anode pin 22 and the cathode pin 23, the cathode pin 23, which is positioned at a lower level, is additionally provided at the bent portion 234 thereof with a curved portion 235. As a result, the length of the anode pin 22 is equal to the length of the cathode pin 23, thereby realizing matching between lengths. Here, for efficient matching between lengths, it is preferable that the radius of curvature of the curved portion 235 be equal to or less than twice the width of the anode pin 22 or the cathode pin 23.

In most conventional high-frequency connectors, in which conductive wires must be individually connected, there is a need to perform the task of individually connecting wires to pins of a finger body. However, because the connector according to the present invention allows all of the pins of the finger unit to be easily connected to the corresponding wires at one time, an operation of connecting the pins of the finger unit to the corresponding wires and connection of signals are easily realized. In addition, because the finger body 1 and the receptacle are naturally maintained in the coupled state, there is an advantage in that the connector provides a highly stable signal connection.

As is apparent from the above description, the present invention conveys an effect of reducing signal interference by virtue of the shield structure between signal lines during high-speed communication and an effect of realizing matching between impedances and improved transmission efficiency by virtue of the dielectric material having low permittivity.

In addition, when there is a need to control impedances in order to match impedances in consideration of the frequency in use, it is possible to selectively control the kind and amount of the dielectric material in order to control an impedance.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A high-speed communication connector, which is of a board-to-board type and is capable of improving communication quality and of controlling communication characteristics, comprising:
a finger body formed at one side of a PCB, the finger body including a plurality of anode terminals formed on one side thereof at predetermined intervals, a plurality of cathode terminals formed on another side thereof at predetermined intervals so as to be symmetrical with the plurality of anode terminals, and shield bodies made of conductive material and formed inside and between the plurality of anode terminals and inside and between the plurality of cathode terminals at predetermined intervals; and
a receptacle body having a groove formed in a side surface thereof so as to be engaged with the one surface and the another surface of the finger body, the receptacle body including a plurality of anode pins and a plurality of cathode pins, which are respectively brought into contact with the plurality of anode terminals and the plurality of cathode terminals for electrical connection, shield plates made of conductive material, the shield plates being interposed between differential lines, each of which is composed of one of the anode pins and a corresponding one of the cathode pins, at predetermined intervals so as to distinguish the differential lines from each other, and pieces of dielectric material having a low permittivity and disposed in spaces defined between the anode pins, the cathode pins, and the shield plates, other than the groove, so as to form a body of the receptacle body, the pieces of dielectric material being selectively controlled in kind and amount so as to control impedances in consideration of frequency bands corresponding to the differential lines, which are isolated from each other by means of the shield plates.

2. The high-speed communication connector according to claim 1, wherein each of the pieces of dielectric material is selected from among Teflon, polyethylene, resin, gutta-percha, Lucite, paraffin, Styrofoam, Vaseline, and ceramic.

3. The high-speed communication connector according to claim 1, wherein the anode pins and the cathode pins include contact portions, which are respectively brought into contact with the anode terminals and the cathode terminals, linear portions spaced apart from and parallel to each other, and exposure portions, which are bent in a predetermined direction so as to be exposed to an outside of the pieces of dielectric material.

4. The high-speed communication connector according to claim 3, wherein each of the anode pins and each of the cathode pins include respective bent portions, which are bent in a predetermined direction, and one of each of the anode pins and each of the cathode pins, which is positioned at a lower level, includes a curved portion formed at the bent portion thereof such that the anode pin and the cathode pins have the same length.

5. The high-speed communication connector according to claim 4, wherein the curved portion has a radius of curvature equal to or less twice width of the anode pin or the cathode pin.
